(19) United States
(12) Patent Application Publication
(10) Pub. No.: US 2026/0020577 A1
(43) Pub. Date: Jan. 22, 2026

(54) Dough Roller Assembly and Method of Cleaning Same

(71) Applicant: Columbia Insurance Company, Omaha, NE (US)

(72) Inventors: Stephanie Michel, Addison, IL (US); Michael Mastroianni, Addison, IL (US); James Hand, Addison, IL (US); Roland Sudmalis, Addison, IL (US); Maurice Luo, Addison, IL (US)

(21) Appl. No.: 19/275,940

(22) Filed: Jul. 21, 2025

Related U.S. Application Data
(60) Provisional application No. 63/673,412, filed on Jul. 19, 2024.

(51) Int. Cl. A21C 3/02; A21C 1/14

(52) U.S. Cl. CPC A21C 3/024; A21C 1/1405; A21C 1/148; A21C 3/021

(57) ABSTRACT

A dough roller assembly including a housing, a first roller, a second roller, and a roller key. The housing has a drive port adapted and configured to receive a drive shaft of a stand mixer. The first roller is within the housing and operably connected to the drive port such that, when the drive port receives the drive shaft of the stand mixer, rotation of the drive shaft of the stand mixer rotates the first roller in a first direction about a first axis of rotation. The second roller is within the housing and operably connected to the first roller such that rotation of the first roller rotates the second roller in a second direction about a second axis of rotation. The roller key is adapted and configured to be received by the drive port and to permit manual rotation of the first and second rollers by a user.

### CROSS-REFERENCE TO RELATED APPLICATIONS

This U.S. non-provisional patent application claims priority to U.S. Provisional patent application 63/673,412, filed Jul. 19, 2024, and titled “Dough Roller Assembly and Method of Cleaning Same,”, the entire disclosure of which is incorporated herein by reference.

### INTRODUCTION

### Field of Invention

This invention pertains to a dough roller assembly and method of cleaning the same.

### SUMMARY

One aspect of the disclosure is a dough roller assembly comprising a housing, a first roller, a second roller, and a roller key. The housing has a drive port adapted and configured to operate the dough roller assembly. The first roller is within the housing and operably connected to the drive port such that rotation of the drive port rotates the first roller in a first direction about a first axis of rotation. The second roller is within the housing and operably connected to the first roller such that rotation of the first roller rotates the second roller in a second direction about a second axis of rotation. The second direction is opposite the first direction and the second axis of rotation is parallel to the first axis of rotation. The roller key is adapted and configured to be received by the drive port when the drive port is not connected to the drive shaft of an appliance and to permit manual rotation of the first and second rollers by a user.

Another aspect of the disclosure is a method of cleaning a dough roller assembly. The drive port of the housing is disconnected from the drive shaft of the appliance. The upper and lower shells are removed from the housing to expose a first exposed portion of the first roller and a first exposed portion of the second roller. The first exposed portions of the first and second rollers are cleaned. The roller key is inserted into the drive port. The roller key is rotated to thereby rotate the first roller in the first direction and the second roller in the second direction to thereby expose a second exposed portion of the first roller and a second exposed portion of the second roller. The second exposed portions of the first and second rollers are cleaned.

Further features and advantages, as well as the operation, are described in detail below with reference to the accompanying drawings.

### BRIEF DESCRIPTION OF THE DRAWINGS

The accompanying drawings, which are incorporated in and form a part of the specification, illustrate the disclosed embodiments and, together with the description, explain certain inventive principles. In the drawings:

FIG. 1 is a top isometric view of an example dough roller assembly mounted on a kitchen appliance in accordance with an embodiment of the disclosure.

FIG. 2 is a top isometric view of an example dough roller assembly in accordance with an embodiment of the disclosure.

FIG. 3 is a top view of the example dough roller assembly in accordance with an embodiment of the disclosure.

FIG. 4 is a bottom view of the dough roller assembly in accordance with an embodiment of the disclosure.

FIG. 5 is a front view of the dough roller assembly in accordance with an embodiment of the disclosure.

FIG. 6 is a rear view of the dough roller assembly in accordance with an embodiment of the disclosure.

FIG. 7 is a top isometric view of the dough roller assembly with the upper shell removed and the roller key inserted into the drive port to show the second exposed portions in accordance with an embodiment of the disclosure.

FIG. 8 is a schematic view of an embodiment of a method for cleaning a dough roller assembly in accordance with an embodiment of the disclosure.

FIG. 9 is a schematic view of an embodiment of another method for cleaning an embodiment of a dough roller assembly in accordance with an embodiment of the disclosure.

Reference numerals in the written specification and in the figures indicate corresponding items.

### DETAILED DESCRIPTION

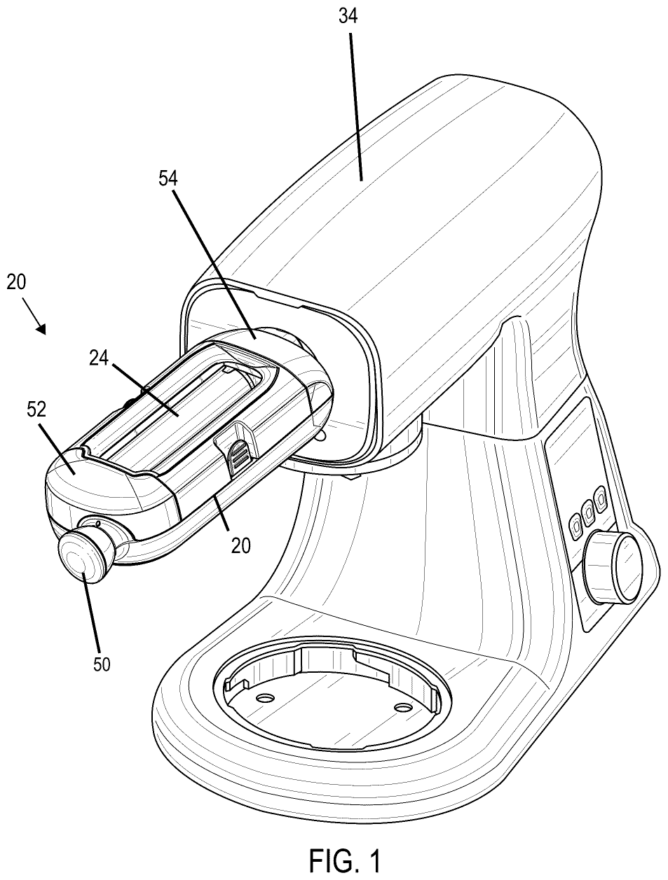

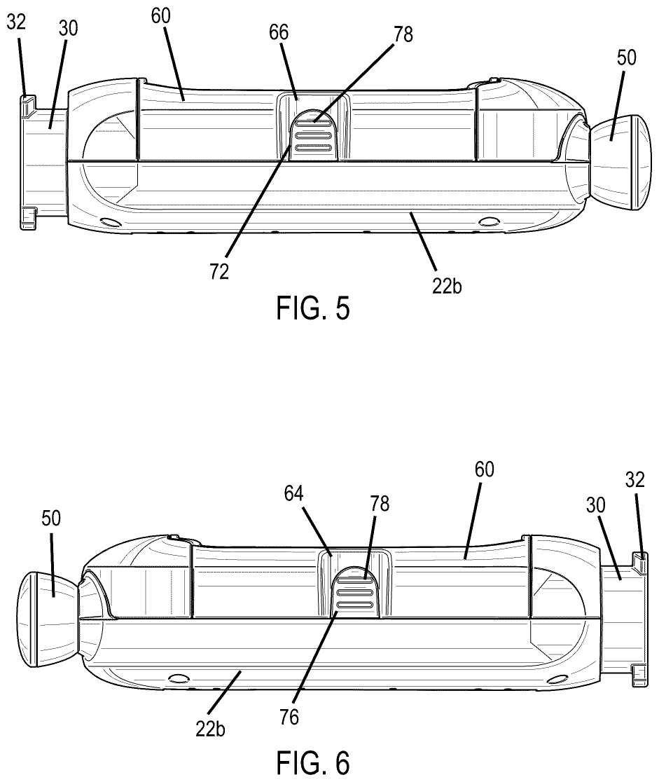

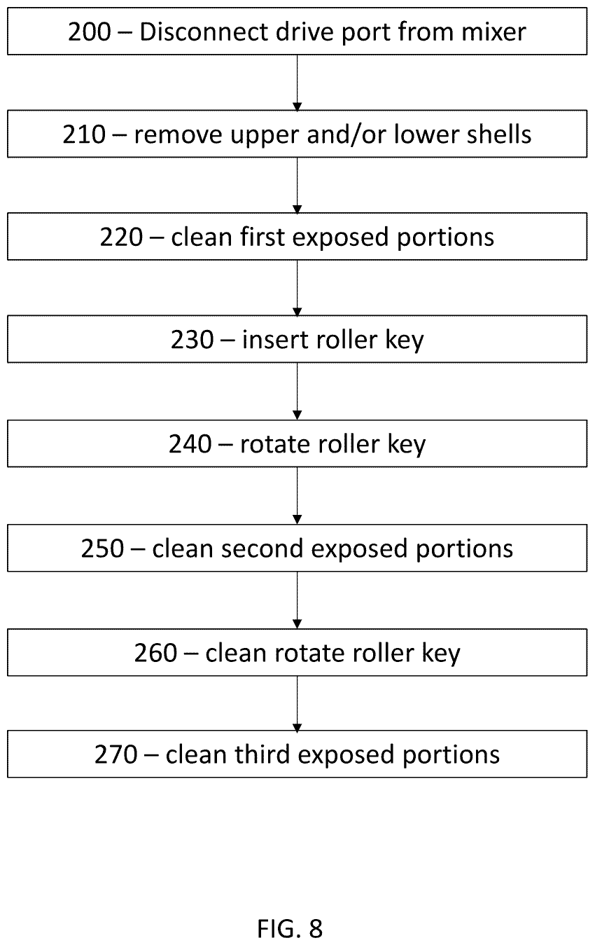

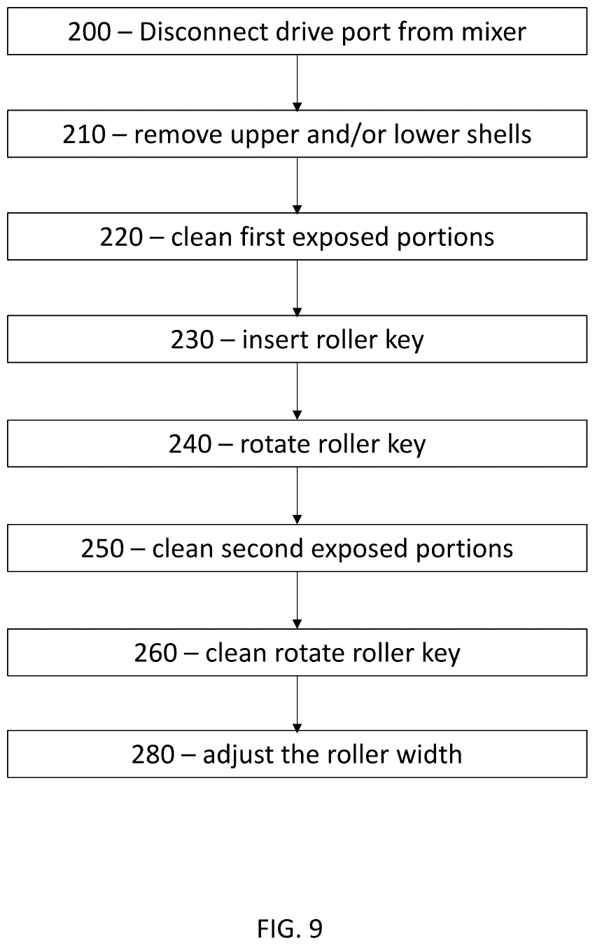

An embodiment of a dough roller assembly, generally indicated by reference number 20, is shown in FIGS. 1-7. FIGS. 8 and 9 illustrate and embodiment or use with the dough roller assembly. As viewed in FIG. 1, the dough roller assembly may be used and attached to a kitchen appliance for operational use. The kitchen appliance viewed in FIG. 1 is a stand mixer 34. However, it should be understood that the dough roller assembly can be configured for use with other appliances such as hand mixers, beaters, blenders or any other devices able to mate and operate the dough roller assembly. The dough roller assembly is envisioned to be used with cooking techniques to assist a cook with food or baking preparations. The dough roller assembly, for example, can be used to create cooking doughs or baking doughs such as those used for creating pasta and pastries. Further, the dough roller assembly may be used in other preparations where rolling, cutting, or forming as shape or design in a food item may be desired by the cook/end user.

The dough roller assembly 20 may connect to the stand mixer 34 in an operative configuration. The dough roller assembly 20 is removably attachable to the stand mixed in the viewed example configuration. Thus, when the end user wished to create a food item with the dough roller assembly 20, the end user may attach the dough roller assembly 20 to the kitchen appliance to create the desired food item. Operation of the dough roller assembly 20 may be powered in some embodiments by the kitchen appliance, e.g. stand mixer 34, when the dough roller assembly 20 is in the attached configuration. In such a configuration, drive mechanisms of each the dough roller assembly 20 and the stand mixer 34 may mate so that operation of the stand mixer in turn operates the dough roller assembly 20. In the attached configuration, the drive mechanism of the stand mixer 34 or kitchen appliance may contact and move the drive mechanism of the dough roller assembly 20. This contact between each of these drive mechanisms allows for the drive mechanism of the dough roller assembly 20 to operate, and its internal components to move, so that the desired cooking technique is accomplished. In other embodiments, the dough roller assembly 20 may be operated manually. While the dough roller assembly 20 can also be operated manual to create food items desired by the end user, manual operation of the dough roller assembly 20 is envisioned to be best used during the cleaning process of the dough roller assembly 20. The disclosed and viewed dough roller assembly 20 can be manually operated to help the end user properly clean the dough roller assembly 20 before it is to be stored for later use.

The dough roller assembly viewed in FIG. 1, and FIGS. 1-7, includes a plurality of component pieces. The example dough roller assembly 20 includes a housing 22, a first roller 24, and a second roller (26, and not viewed in FIG. 1). At a first side 52 of the dough roller assembly 20, a knob 50 may be present. Opposite the knob 50, a second side 54 of the dough roller assembly 20 may include a port 30 with the drive mechanism of the dough roller assembly 20. As illustrated in FIG. 1, much of the drive port 30 of the dough roller assembly 20 is not viewable as it is correctly attached to the stand mixer 34 to place the dough roller assembly 20 in an operational configuration. In correct attachment between the drive port 30 and the kitchen appliance with not all for operation of the dough roller assembly 20.

Additionally, the dough roller assembly 20 may include a key 28. The key 28 is not viewed in FIG. 1 as use of the key 28 with the dough roller assembly 20 is accomplished when the dough roller assembly 20 is not connected to a kitchen appliance for operation. The key 28 can be used with the dough roller assembly 20 to manually operate the dough roller assembly 20 when it is detached from the stand mixer 34 or any other kitchen appliance. In the following paragraphs additional details of each the key 28, the components of the dough roller assembly 20, and operation of the dough roller assembly 20 are discussed.

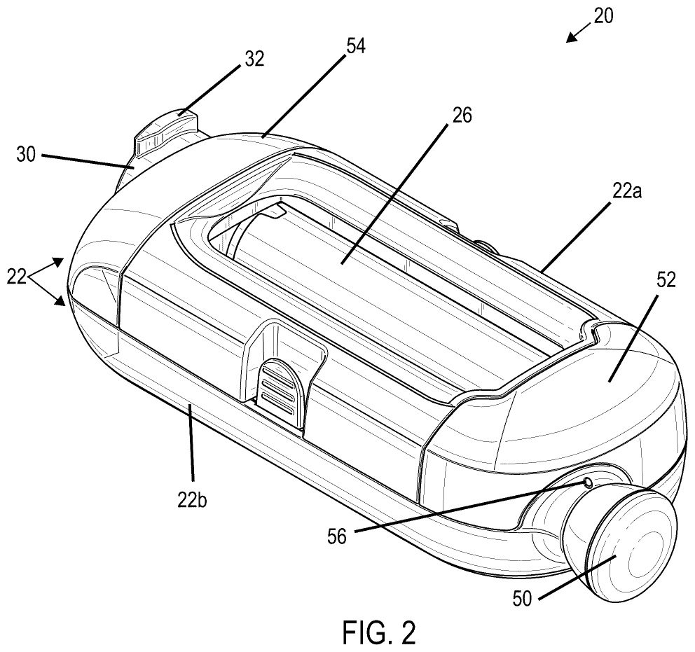

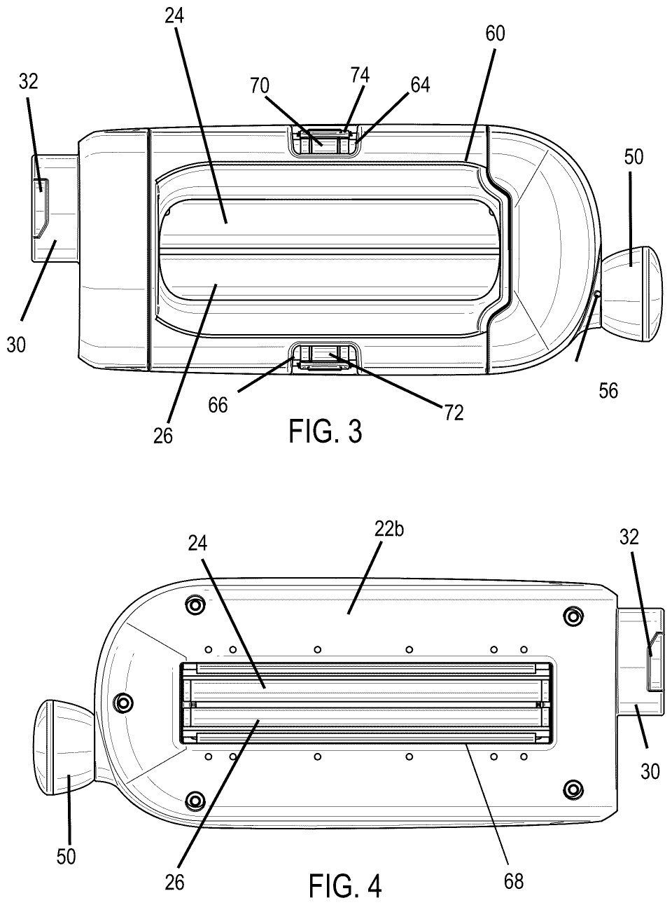

Turning to FIGS. 2-4, various views of the dough roller assembly 20 are illustrated. FIG. 2 is a top isometric view of an example dough roller assembly 20. FIG. 3 is a top view of the example dough roller assembly, and FIG. 4 is a bottom view of the example dough roller assembly 20. In FIG. 2, the dough roller assembly 20 is detached from the kitchen appliance or stand mixer 34. The dough roller assembly 20 includes a housing 22, a first roller (24, and not viewed in FIG. 1), and a second roller 26. The positional view of the dough roller assembly 20 illustrated in FIG. 2 is different that the positional view illustrated in FIG. 1 allowing for the second roller 26 to be viewed. The housing 22 of the dough roller assembly 20 may surround and partial enclose each the first roller 24 and the second roller 26 within the housing 22.

At the second side 54, the housing 22 has a drive port 30 adapted and configured to receive a drive shaft of a kitchen appliance, such as stand mixer 34, or the key 28. The drive port 30 may have a plurality of locking arms 32 that can mate the dough roller assembly 20 with one or more kitchen appliances like stand mixers 24. The plurality of locking arms may be a different design or configuration depending on the appliance to which the dough roller assembly 20 may connect. At the first side 52, the housing has a knob 50 protruding outward from the first side. The knob may be a rotatable mechanism. The knob viewed in FIG. 2 is circular and tapered downward where the knob 50 meets the housing 22, but other design configurations of the knob 50 are envisioned and possible. The knob 50 connects inside the housing 22 via an internal knob mechanism, such as a shaft, to either the first roller 24 or second roller 26. Manipulation of the knob 50 via rotation can moved the placement of either the first roller 24 or the second roller 26. As viewed in FIG. 2, the knob 50 is internally attached to the first roller 24. The know may be rotated in either a clockwise or counterclockwise direction. Rotation of the knob 50 can adjust the horizontal dimensions of the space found between the first roller 24 and the second roller 26 viewed through the opening 62 and within the housing 22. For example, rotating the knob 50 clockwise may increase the size of the space and the distance between the first roller 24 and second roller 26. Alternatively, rotating the knob 50 counter clockwise may decrease the size of the space and the distance between the first roller 24 and second roller 26. In operation, using of the knob 50 of the dough roller assembly 20 the end user can select a desire thickness for the created food item as it passes through the opening and downward between the first roller 24 and second roller 26. The knob 50 allows the user to further adjust and change the desire thickness during operation to meet the desired thickness of the food item being created with the dough roller assembly 20. To identify a spacing setting of the dough roller assembly 20, the first side 52 of the dough roller assembly 20 may have an indicator 56. The indicator may match a knob setting that may be displayed to the end user and placed on the outer side surface of the knob 50. The knob setting may be a visual indicator such as a line in increasing length, or a printed number or letter, or a textured indication that communicates to the end user the current thickness setting of the dough roller assembly 20.

The housing of the dough roller assembly 20 may comprise an upper shell 22a and a lower shell 22b. The upper shell 22a and/or the lower shell 22b may mate together to form the overall housing 22 of the dough roller assembly 20. may be removable from the housing 22. The housing 22 of the dough roller assembly 20 may surround and partial enclose each the first roller 24 and the second roller 26 within the housing 22. The housing 22 may have a cover 60 that is part of the upper shell 22a. The cover 60 along with the top portion of the first side 52 and the top portion of the second side 54 create the upper shell 22a of the dough roller assembly 20. The cover 60 have an opening 62 that allows for access into the interior of the housing. During operation, the opening 62 allows for food items to be fed into the dough roller assembly 20.

The first roller 24 of the dough roller assembly 20 is within the housing 22 and operably connected to the drive port 30. This connection between the drive port 30 and the first roller 24 allows the drive port 30 to receive a corresponding the drive shaft from a kitchen appliance such as the stand mixer 34. In operation, rotation of the drive shaft of the stand mixer 34 rotates the first roller 24 in a first direction D₁ about a first axis of rotation X₁. The second roller 26 is within the housing 22 and operably connected to the first roller 24 such that rotation of the first roller 24 rotates the second roller 26 in a second direction D₂ about a second axis of rotation X₂. The second direction D₂ is opposite the first direction D₁ and the second axis of rotation X₂ is parallel to the first axis of rotation X₁. The first and second rollers 24, 26 may comprise a variety of materials. For example, the first and second rollers 24, 26 may comprise a metal or alloy (e.g., steel, stainless steel, copper, aluminum, etc.). Alternatively, the first and second rollers 24, 26, may comprise polymers (e.g., high-density polyethylene (HDPE), polyvinyl chloride (PVC), or the like) or silicone. Yet another alternative, the first and second rollers 24, 26 may comprise a natural material such as wood or stone (e.g., marble or granite). The first and second rollers 24, 26 may further comprise a non-stick material.

The first and second rollers 24, 26 may take on a variety of designs or configurations. For example, and as viewed in FIGS. 2-6, the first roller 24 and the second roller 26 are elongated cylinders with a flat surface. In operational use, first and second rollers 24, 26 with a flat surface smooth and flatten the desired food item as it is fed into and through the dough roller assembly 20. In other embodiments, the first roller 24 may further comprise a plurality of first blades, and the second roller 26 may further comprise a plurality of second blades. The first and second pluralities of blades may be adapted and configured to slice a dough into strips or to create patterns on a sheet of dough. In other configurations, the surface of each the first and second rollers 24, 26 may have a stamped design or pattern to be pressed into the food item or dough as it is fed into the through the dough roller assembly 20. As referred to herein, dough is used generally and may include—but is not limited to—pasta dough, filo dough, shortbread dough, cookie dough (e.g., sugar cookies), pita or flatbread dough, pizza dough, or the like. Each of the blades of the plurality of first blades have a thickness T_{FB}, and each of the blades of the plurality of second blades have a thickness T_{SB}. A majority of the blades of the plurality of first blades 36 may have a thickness T_{FB} of between 0.05 and 0.1 inches, and a majority of the blades of the plurality of first blades 36 may have a thickness T_{SB} of between 0.05 and 0.1 inches. Alternatively, a majority of the blades of the plurality of first blades may have a thickness T_{FB} of between 0.1 and 0.2 inches, and a majority of the blades of the plurality.

The pluralities of first and second blades may each comprise at least five blades. The pluralities of first and second blades may each comprise at least ten blades. The pluralities of first and second blades may each comprise at least fifteen blades. The pluralities of first and second blades may each comprise at least twenty blades. The pluralities of first and second blades may each comprise at least twenty-five blades. The pluralities of first and second blades may each comprise at least thirty blades.

As viewed in FIGS. 2-6, the first roller 24 is cylindrical, and has a profile that is circular in a cross section taken in a plane perpendicular to the first axis of rotation X₁ (FIG. 14). Likewise, the second roller 26 is cylindrical, and has a profile that is circular in a cross section taken in a plane perpendicular to the first axis of rotation X₂ (FIG. 14). The first roller 24 has a first roller diameter D₁, and the second roller 26 has a second roller diameter D₂. The diameters D₁, D₂ may be between 0.75 and 1.5 inches.

The first roller 24 and the second roller 26 are spaced a roller width W. As stated earlier, the dough roller assembly 20 may further comprise a knob 50. The knob 50 is operably coupled to the second roller, and is adapted and configured to vary the roller width W. The roller width W may be variable between 0.0625 inches and 0.5 inches and is preferably variable between 0.0625 inches and 0.125 inches. The variable width enables a user to roll dough to a desired thickness based on the user's needs.

In FIG. 3, the upper shell 22A of the dough roller assembly 20 is viewed. The cover 60 may be centered along the length of the dough roller assembly 20. Along with opening 62, the cover may have a first cover opening 64 and a second cover opening 66. The first and second cover openings 64, 66 may be aligned with one another and located at opposite ends of the cover 60. Each the first and second cover openings 64, 66 allow for a tabs of the lower shell 22b to pass through the openings when the cover 60 is placed and aligned with the lower shell 22b of the housing 22. The lower shell may include a plurality of tabs that extend upward from the lower tab. For example, a first tab 70 and a second tab 72 may be present. The first tab 70 and the second tab 72 may be aligned with one another and located at opposite ends of the lower shell 22b. The first tab 70 and the second tab 72 may also align with the first cover opening 64 and the second cover opening 66. When the removable cover 60 is placed upon the lower shell 22b of the housing 22, the first and second tab 70, 72 secure the position of the cover 60 in place and as part of the housing 22. The first and second tabs 70, 72 may be flexible, and have a locking shelf 74 so that the first and second tabs 70, 72, such that when the first and second tabs 70, 72 pass through the first and second cover openings 62, 64 the first and second tabs 70, 72 contact the cover surface near each the first and second cover openings 62, 64. In this manner the cover 60 is secured and the dough roller assembly 20 can be moved without worry of the cover 60 disconnected from the assembled unit. Additionally, the first and second tabs 70, 72 may have a grip 78 to help the user manipulate and grasp the tabs to remove or attach the cover 60. The grip 78 may be a plurality of ridges or any other type of material or component that aids a user to have a focused grasp on either the first or second tabs 70, 72.

The cover 60 is a removable panel that can be mated and released from the lower shell 22b. During operation, the cover 60 should be secured with the lower shell 22b via the first and second tabs 70, 72. When the dough roller assembly 20 is not in operation, the cover 60 can be removed from its connection to the lower shell 22b. To accomplish this, the user may depress each the first tab 70 and the second tab 72 toward the center of the dough roller assembly 20. Depressing each the first and second tabs 70, 72 in such a manner will release the locking shelf from contacting the cover 60. With the cover 60 unlocked, the user may simply lift and remove the cover 60 from dough roller assembly 20. Removing the cover 60 from the dough roller assembly 20 assists the user in cleaning the dough roller assembly 20. During operation, the dough roller assembly 20 may collect debris and food particles on either the first or second roller 24, 26 or within the internal space inside the housing 22. Removing the cover 60 allows the end user access to the entire surface of each the first and second roller 24, 26 and the interior of the housing 22 so that the dough roller assembly 20 can be properly cleaned and all remaining debris or food particles removed. This allows for the dough roller assembly 20 to be safely stored before risk of operational issues or health concerns occurring with later use of the dough roller assembly 20.

As viewed in FIG. 4, the lower shell 22b is viewed. The lower shell 22b may contain a lower opening 68 that is generally aligned with opening 62 located on the top of the dough roller assembly 20. The lower opening 68 allows food items to exit as they are fed into the dough roller assembly 20, pressed between the first and second rollers 24, 26, and finally exiting from the lower opening 68.

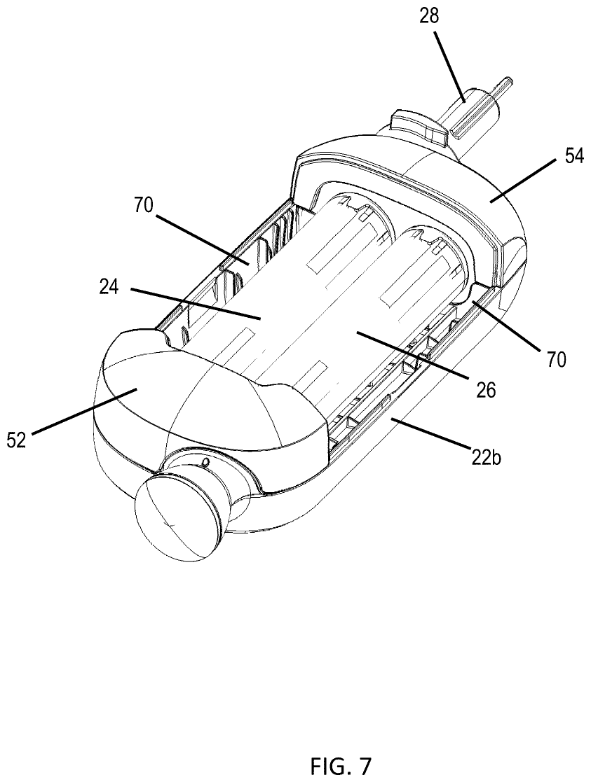

FIG. 7. Illustrates the dough roller assembly 20 with the cover 60 removed. This is the cleaning position of the dough roller assembly 20. As viewed in FIG. 7. The entire length of each the first and second roller 24,26 can be accessed by the end user for cleaning purposes. Furthermore, the end user can access the interior space 70 within the housing that may build up with food particles debris to properly remove such unwanted items from the dough roller assembly 20.

FIG. 7 also illustrate the key 28 that can be used with the dough roller assembly 20. The key 38 can connect and mate with port 30 in the same manner the dough roller assembly 20 may attach to a kitchen appliance like a stand mixer 34. The key 28, can allow for manual use of the dough roller assembly 20 if desired. However, the key 28 is best used in the cleaning operation of the dough roller assembly 20. The roller key 28 is adapted and configured to be received by the drive port 30 when to permit manual rotation of the first and second rollers 24, 26 by a user. When inserted and mated with the port 30, the key 28 can be manipulated by the end user. The user can rotate the key 28 clockwise or counter clockwise. This rotation will in turn rotate the first roller 24 and the second roller 26. Rotating these rollers manually allows for the end user to access the entire surface area of each the first and second rollers 24, 26 to properly clean each roller. Further, rotation of the first and second rollers 24, 26 with the cover 60 removed from the dough roller assembly 20 can allow the end user to dislodge additional food particles that can be removed during the cleaning operation.

A method of cleaning the dough roller assembly 66 is shown in FIGS. 8-9. The above description of the dough roller assembly 20 of FIGS. 1-7 applies equally to the dough roller assembly of FIGS. 8-9 except 8-9 the differences noted in the description of the embodiment of FIGS. 8-9 or as shown in the drawings of FIGS. 8-9. It is also to be understood that the components, elements, features, or regions of the embodiment of FIGS. 8-9 have reference numbers corresponding to the reference numbers of the embodiments of FIGS. 1-7, except the reference numbers of the embodiment of FIGS. 8-9 include a prefix “1.”

When dough is rolled, some dough may remain within the housing 122 and on the surfaces of the rollers 124, 126. It is desirable to remove such dough and clean the housing 122 and rollers 124, 126 to maintain the dough roller assembly 66 in good working order and to prevent contamination of future dough batches with the dried and/or spoiled dough within the housing. Following the use of the dough roller assembly 66 in connection with a kitchen appliance such as a stand mixer 134 to roll dough, the drive port 130 of the housing 122 is disconnected from the drive shaft 132 of the stand mixer 134 or kitchen appliance. This is shown at step 200. The upper and/or lower shells 122a, 122b are removed from the housing 122 to expose a first exposed portion 142 of the first roller 124 and a first exposed portion 144 of the second roller 126. This is shown at step 210. The first exposed portions 142, 144 of the first and second rollers 124, 126 are cleaned. This is shown at step 220. The roller key 128 is inserted into the drive port 130. This is shown at step 230. The roller key 128 is rotated to thereby rotate the first roller 124 in the first direction and the second roller 126 in the second direction to thereby expose a second exposed portion 146 of the first roller and a second exposed portion 148 of the second roller. This is shown at step 240. The second exposed portions 146, 148 of the first and second rollers are cleaned. This is shown at step 250. This process may be repeated as needed. For instance, the roller key 128 may be further rotated to thereby expose a third exposed portion 150 of the first roller and a third exposed portion 152 of the second roller. This is shown at step 260. The third exposed portions 150, 152 of the first and second rollers may likewise be cleaned. This is shown at step 270.

The method may alternatively comprise pulling the roller width adjustment knob 140 away from the housing 122 and rotating the roller width adjustment knob to adjust the roller width W. This is shown at step 280 in FIG. 18. Additionally, in both the method of FIGS. 7 and 8, the interior space 70 of the housing 22 can also be cleaned by the user as the user removes or dislodges any collected food particles or waste from the interior space 70.

In view of the foregoing, it should be appreciated that the invention has several advantages over the prior art.

It should also be understood that when introducing elements of the present invention in the claims or in the above description of exemplary embodiments of the invention, the terms “comprising,” “including,” and “having” are intended to be open-ended and mean that there may be additional elements other than the listed elements. Additionally, the term “portion” should be construed as meaning some or all of the item or element that it qualifies. Moreover, use of identifiers such as first, second, and third should not be construed in a manner imposing any relative position or time sequence between limitations.

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments but should be defined only in accordance with the following claims appended hereto and their equivalents.

What is claimed is:

1. A dough roller assembly comprising:
a housing, a first roller, a second roller, and a roller key, the housing having a port adapted and configured to operate the dough roller, the first roller being within the housing and operably connected to the drive port such that use of the drive port rotates the first roller in a first direction about a first axis of rotation, the second roller being within the housing and operably connected to the first roller such that rotation of the first roller rotates the second roller in a second direction about a second axis of rotation, the second direction being opposite the first direction, the second axis of rotation being parallel to the first axis of rotation;
a cover of the housing, the cover being removably attached to the housing during active operation of the dough roller assembly; and
a roller key, the roller key adapted and configured to be received by the drive port to permit manual rotation of the first and second rollers by a user.

2. The dough roller assembly of claim 1 wherein the housing comprises an upper shell and a lower shell, the upper and lower shells being removable from the housing.

3. The dough roller assembly of claim 2 wherein the first roller further comprises a plurality of first blades and wherein the second roller further comprises a plurality of second blades, the first and second pluralities of blades being adapted and configured to slice a dough into strips or to create patterns on a sheet of dough.

4. The dough roller assembly of claim 2 wherein a majority of the plurality of first blades has a thickness of between 0.05 and 0.1 inches and a majority of the plurality of second blades has a thickness of between 0.05 and 0.1 inches.

5. The dough roller assembly of claim 4 wherein the plurality of first blades comprises at least 20 blades and the plurality of second blades comprises at least 20 blades.

6. The dough roller assembly of claim 2 wherein a majority of the plurality of first blades has a thickness of between 0.1 and 0.2 inches and a majority of the plurality of second blades has a thickness of between 0.1 and 0.2 inches.

7. The dough roller assembly of claim 6 wherein the plurality of first blades comprises at least 10 blades and the plurality of second blades comprises at least 10 blades.

8. The dough roller assembly of claim 2 wherein the first and second rollers are spaced by a roller width, the dough roller assembly further comprising a roller width adjustment knob, the roller width adjustment knob being operably coupled to the second roller and adapted and configured to vary the roller width.

9. The dough roller assembly of claim 8 wherein the roller width is variable between 0.0625 and 0.125 inches.

10. A method of cleaning a dough roller assembly, the dough roller assembly comprising a housing, a first roller, and a second roller, the housing comprising an upper shell and a lower shell, the upper and lower shells being removable from the housing, the housing having a drive port adapted and configured to receive a drive shaft of a stand mixer, the first roller being within the housing and operably connected to the drive port such that, when the drive port receives the drive shaft of the stand mixer, rotation of the drive shaft of the stand mixer rotates the first roller in a first direction about a first axis of rotation, the second roller being within the housing and operably connected to the first roller such that rotation of the first roller rotates the second roller in a second direction about a second axis of rotation, the second direction being opposite the first direction, the second axis of rotation parallel to the first axis of rotation, the method comprising:
disconnecting the drive port of the housing from the drive shaft of the stand mixer;
removing the upper and lower shells from the housing to expose a first exposed portion of the first roller and a first exposed portion of the second roller;
cleaning the first exposed portions of the first and second rollers;
inserting a roller key into the drive port;
rotating the roller key to thereby rotate the first roller in the first direction and the second roller in the second direction to thereby expose a second exposed portion of the first roller and a second exposed portion of the second roller; and
cleaning the second exposed portions of the first and second rollers.

11. The method of claim 10, further comprising rotating the roller key to thereby expose a third exposed portion of the first roller and a third exposed portion of the second roller; and
cleaning the third exposed portions of the first and second rollers.

12. The method of claim 10, wherein the first and second rollers are spaced by a roller width, the dough roller assembly further comprises a roller width adjustment knob, the roller width adjustment knob being operably coupled to the second roller and adapted and configured to vary the roller width, the method further comprising pulling the roller width adjustment knob away from the housing and rotating the roller width adjustment knob to adjust the roller width.
